(19) United States
(12) Patent Application Publication
(10) Pub. No.: US 2026/0029923 A1
(43) Pub. Date: Jan. 29, 2026

(54) DATA BLOCK VALIDITY FOR MAINTENANCE OPERATIONS

(71) Applicant: Micron Technology, Inc., Boise, ID (US)

(72) Inventors: Chaohui Liu, Shanghai (CN); Liang Ge, Shanghai (CN); Nicola Colella, Capodrise (CE) (IT)

(21) Appl. No.: 19/271,612

(22) Filed: Jul. 16, 2025

Related U.S. Application Data
(60) Provisional application No. 63/676,284, filed on Jul. 26, 2024.

(51) Int. Cl. G06F 3/06

(52) U.S. Cl. CPC G06F 3/0613; G06F 3/064; G06F 3/0673

(57) ABSTRACT

Methods, systems, and devices for data block validity for maintenance operations are described. For example, a memory system may receive and store an indication of valid and invalid pages of a first memory block. As part of a release or background operation, the memory system may transfer data that is indicated to be valid from the first memory block to a second memory block. In some examples, the memory system may refrain from transferring the invalid data of the first memory block, while in other examples the memory system may also transfer the invalid data to a third memory block. The memory system may designate the first memory block as a free memory block in response to transferring the valid data, and may utilize the newly freed first memory block in subsequent access operations.

### CROSS REFERENCE

The present application for patent claims priority to U.S. Patent Application No. 63/676,284 by Liu et al., entitled “DATA BLOCK VALIDITY FOR MAINTENANCE OPERATIONS,” filed Jul. 26, 2024, which is assigned to the assignee hereof, and which is expressly incorporated by reference in its entirety herein.

### TECHNICAL FIELD

The following relates to one or more systems for memory, including data block validity for maintenance operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports data block validity for maintenance operations in accordance with examples as disclosed herein.

FIGS. 2A, 2B, and 2C show examples of memory block configurations that support data block validity for maintenance operations in accordance with examples as disclosed herein.

FIGS. 3 and 4 show examples of processes that support data block validity for maintenance operations in accordance with examples as disclosed herein.

FIGS. 5 and 6 show block diagrams of memory systems that support data block validity for maintenance operations in accordance with examples as disclosed herein.

FIGS. 7 and 8 show flowcharts illustrating a method or methods that support data block validity for maintenance operations in accordance with examples as disclosed herein.

### DETAILED DESCRIPTION

Some memory systems may utilize an append-logging policy if storing data to memory or performing other filing operations. In some examples, in using the append-logging policy, the memory system may sequentially write data to pages of a block of memory without overwriting data. In the case that a file may need to be updated, the memory system may allocate a new memory block and invalidate the old memory block. The memory system may utilize a table (e.g., a page valid table (PVT)) to record which memory blocks are valid and invalid. Similarly, an associated host system may use a table (e.g., a segment information table (SIT)) for similar purposes. In some instances, a mismatch between the tables may occur. For example, the host system may indicate (e.g., record) that data is invalid in an associated SIT prior to sending an unmap command to the memory system. Eventually, the host system may send an unmap command to the memory system and then the memory system may indicate the data as invalid in the associated PVT. Due to such timing mismatches, the memory system may be unaware of which of the blocks are marked as invalid at the host system, and thus may move data from a block that is valid at the memory system but invalid to the host system during garbage collection operations or other background operations, which may result in system inefficiency and performance degradation.

To increase the efficiency and performance of various background operations, a memory system may identify which memory blocks are valid at the host system and may perform one or more operations to preserve data that is valid at both the memory system and at the host system. The memory system may identify which memory blocks are valid by receiving the SIT (e.g., or a portion of the SIT) from the host system. For example, a memory system may receive and store an indication of valid and invalid pages of a first memory block (e.g., pages that are valid or invalid to the host system). As part of a release or background operation, the memory system may transfer data that is indicated to be valid from the first memory block to a second memory block. In some examples, the memory system may also transfer the invalid data to a third memory block. The memory system may designate the first memory block as a free memory block in response to transferring the valid data, and may utilize the newly freed first memory block in future write operations. In some examples, the memory system may designate the first memory block as a free memory block as part of a self-unmap operation.

In some examples, the memory system may refrain from transferring invalid data from the first memory block. For example, a memory system may receive and store an indication of valid and invalid pages of a first memory block (e.g., pages that are valid or invalid to the host system). As part of a release or background operation, the memory system may transfer data that is indicated to be valid from the first memory block to a second memory block and may refrain from transferring the invalid data from the first memory block. The memory system may designate the first memory block as a free memory block in response to transferring the valid data, in response to an unmap command, or both, and may utilize the newly freed first memory block in future write operations. By identifying which memory blocks of the memory system are valid and invalid to both the memory system and the host system, the memory system may be enabled to perform one or more operations to preserve valid data, which may increase efficiency and performance of the memory system.

In addition to applicability in memory systems as described herein, techniques for data block validity indications for use in maintenance operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems and in the improvement of various electronic device and system performance as described herein, techniques for data block validity indications for use in maintenance operations may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by eliminating production processes, which may extend the life of electronic devices and thereby reducing electronic waste, among other benefits.

Features of the disclosure are illustrated and described in the context of systems, devices, and circuits. Features of the disclosure are further illustrated and described in the context of memory block configurations, processes, and flowcharts.

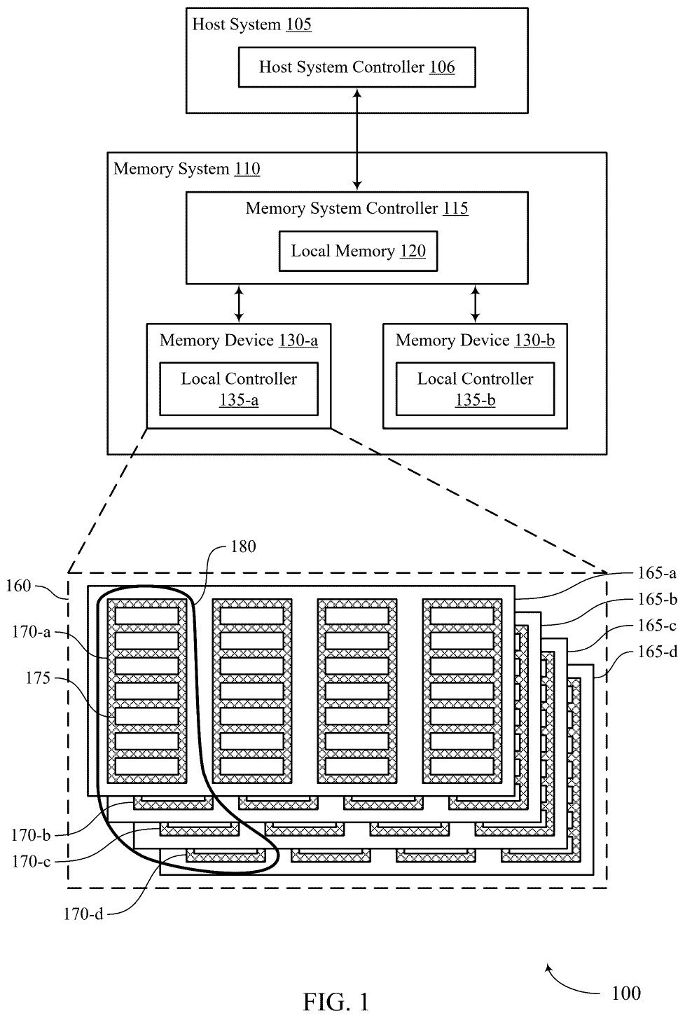

FIG. 1 shows an example of a system 100 that supports data block validity for maintenance operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170 (e.g., memory blocks 170), where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may utilize an append-logging policy if storing data to memory or performing other filing operations. In some examples, in using the append-logging policy, the memory system 110 may sequentially write data to pages 175 of a block 170 of memory without overwriting data. In the case that a file may need to be updated, the memory system 110 may allocate a new memory block 170 and invalidate the old memory block 170. The memory system 110 may utilize a table (e.g., a page valid table (PVT)) to record which memory blocks 170 are valid and invalid. Similarly, an associated host system 105 may use a table (e.g., a segment information table (SIT)) for similar purposes. In some instances, a mismatch between the tables may occur. For example, the host system 105 may indicate (e.g., record) that data is invalid in an associated SIT prior to sending an unmap command to the memory system 110, after which time the memory system 110 may indicate the data as invalid in the associated PVT. Due to such timing mismatches, the memory system 110 may be unaware of which of the blocks 170 are marked as invalid at the host system 105, and thus may move data from a block 170 that is valid at the memory system 110 but invalid to the host system 105 during garbage collection operations or other background operations, which may result in system inefficiency and performance degradation.

To increase efficiency and performance in various background operations, the memory system 110 may identify which memory blocks 170 are valid at the host system 105 and may perform one or more operations to preserve data that is valid at both the memory system 110 and at the host system 105. The memory system 110 may identify which memory blocks 170 are valid by receiving the SIT (e.g., or a portion of the SIT) from the host system 105. For example, a memory system 110 may receive and store an indication of valid and invalid pages of a first memory block 170 (e.g., pages that are valid or invalid to the host system). As part of a release or background operation, the memory system 110 may transfer data that is indicated to be valid from the first memory block 170 to a second memory block 170. In some examples, the memory system 110 may also transfer the invalid data to a third memory block 170. The memory system 110 may designate the first memory block 170 as a free memory block 170 in response to transferring the valid data, and may utilize the newly-freed first memory block 170 in future write operations. In some examples, the memory system may designate the first memory block as a free memory block as part of a self-unmap operation.

In some examples, the memory system 110 may refrain from transferring invalid data from the first memory block 170. For example, the memory system 110 may receive and store an indication of valid and invalid pages of a first memory block 170 (e.g., pages that are valid or invalid to the host system 105). As part of a release or background operation, the memory system 110 may transfer data that is indicated to be valid from the first memory block 170 to a second memory block 170, and may refrain from transferring the invalid data of the first memory block 170. The memory system 110 may designate the first memory block 170 as a free memory block 170 in response to transferring the valid data, in response to an unmap command, or both, and may utilize the newly-freed first memory block 170 in future write operations. By identifying which memory blocks 170 of the memory system 110 are valid and invalid to the host system 105 and the memory system 110, the memory system 110 may be enabled to perform one or more operations to preserve valid data, which may increase efficiency and performance of the memory system 110.

The system 100 may include any quantity of non-transitory computer readable media that support data block validity for maintenance operations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

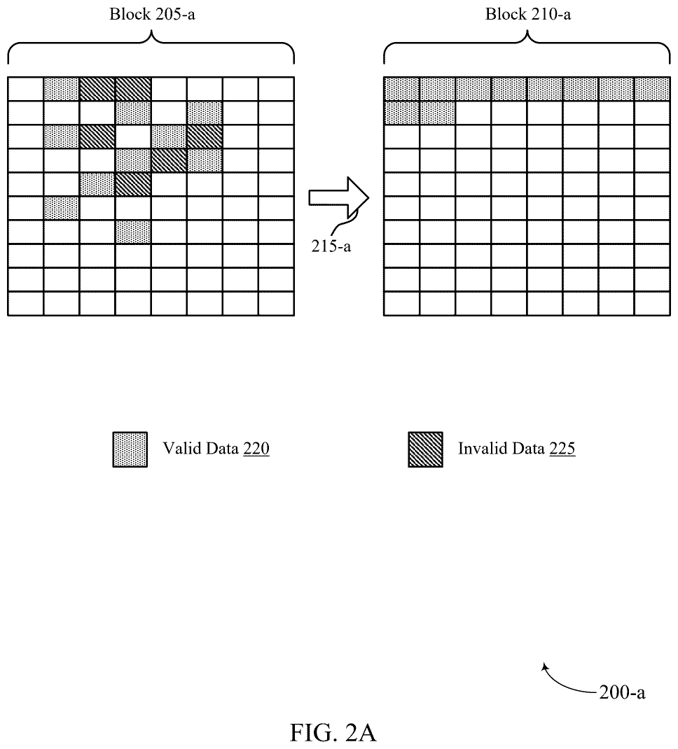

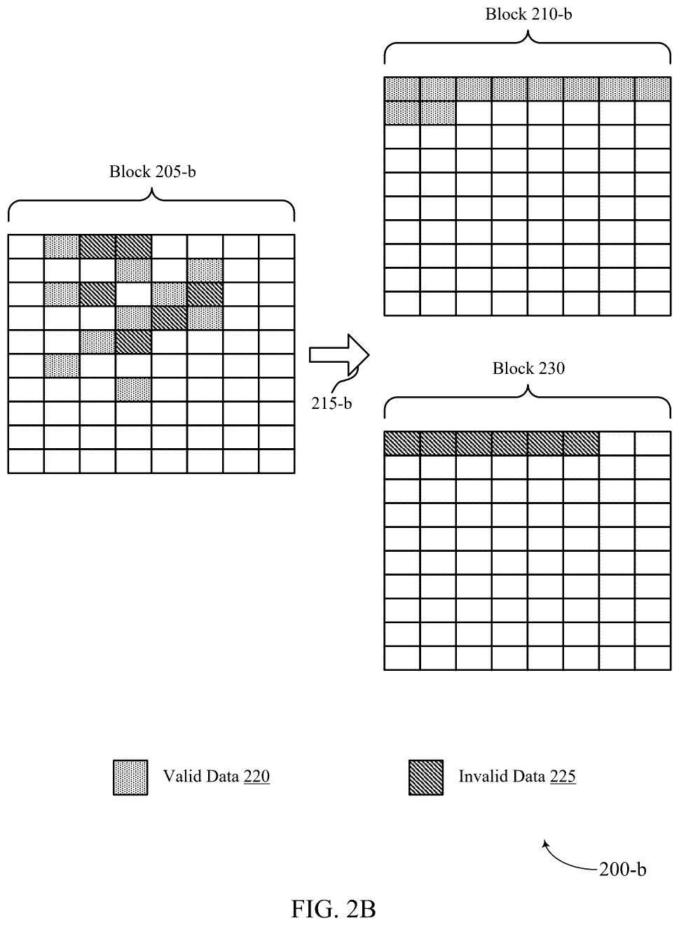

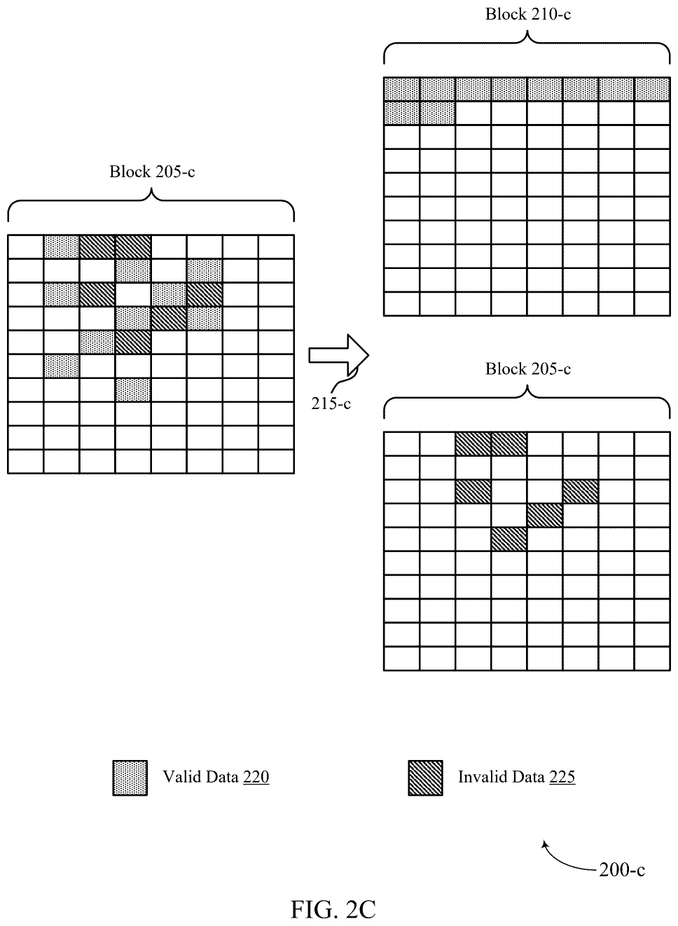

FIGS. 2A, 2B, and 2C show examples of memory block configurations 200 that support data block validity for maintenance operations in accordance with examples as disclosed herein. For example, FIG. 2A shows an example of a memory block configuration 200-a, FIG. 2B shows an example of a memory block configuration 200-b, and FIG. 2C shows an example of a memory block configuration 200-c. The memory block configurations 200 may be examples of or be implemented by a system 100, or components thereof, as described with reference to FIG. 1, or aspects thereof. For example, the memory block configurations 200 may include one or more memory blocks (e.g., a memory block 205, a memory block 210, and a memory block 230) that may be examples of a block 170 as described with reference to FIG. 1.

A memory system may utilize an append-logging policy if storing data to memory or performing other filing operations. In some examples, in using the append-logging policy, the memory system may sequentially write data to pages of a block of memory without overwriting data. In the case that a file may need to be updated, the memory system may allocate a new memory block and invalidate the old memory block. The memory system may utilize a table (e.g., a PVT) to record which memory blocks are valid and invalid. Similarly, an associated host system may use a table (e.g., a SIT) for similar purposes. In some instances, a mismatch between the tables may occur. For example, the host system may indicate (e.g., record) that data is invalid in an associated SIT prior to sending an unmap command to the memory system, after which time the memory system may indicate the data as invalid in the associated PVT. Due to such timing mismatches, the memory system may be unaware of the blocks are marked as invalid at the host system, and thus may move data from a block that is valid at the memory system but invalid to the host system during garbage collection operations or other background operations, which may result in system inefficiency and performance degradation.

The host system may keep track of which memory blocks (e.g., and data thereof) stored to the memory system are valid (e.g., at the host system) using a SIT. During certain operations, the host system may store the starting addresses of data stored to memory blocks of the memory system in a SIT, starting from segment 0 of the SIT. The SIT may use a structure code to maintain a bitmap to keep track of memory blocks that may be valid at the host system. For example, the SIT may maintain the bitmap according to a code. In some examples, each SIT entry may manage a single segment (e.g., 512 memory blocks) of information. Each SIT memory block in the SIT may maintain 55 SIT entries, and each entry may be maintained according to a code. The host system may indicate validity of data to the memory system.

During an access operation, the host system may access an entry of the SIT associated with data that is valid at the host system (e.g., segment 0). The host system may send the address of the SIT entry, the address of the SIT, and the SIT structure to the memory system. In some examples, the host system may transmit the addresses to the memory system via a vendor unique (VU) command. The memory system may receive the address of the SIT entry, the address of the SIT, and the SIT structure from the host system, and may locate the corresponding memory block in the memory system. The memory system may locate the memory block by performing one or more calculations based on the following equation:

$$valid memory block = starting LBA of SIT region + \frac{\frac{LBA of victim block - starting LBA of segment 0}{512}}{55}$$

After identifying the valid memory block, the memory system may be able to reduce the movement of data that is indicated as being invalid at the host system during various background operations, such as garbage collection operations. The memory system may identify that the memory blocks are valid via receiving the SIT (e.g., or a portion of the SIT) from the host system. For example, a memory system may receive and store an indication of valid data 220 and invalid data 225 of a first memory block 205. As part of a release or background operation, the memory system may transfer valid data 220 (e.g., data indicated to be valid at both the memory system and the host system) from the first memory block 205 to a second memory block 210. In some cases, the invalid data 225 may not be utilized by the memory system or the host system, thus the invalid data 225 may ultimately be removed (e.g., erased).

For example, a first example may include the memory system discarding the data that may be valid at the memory system but invalid at the host system (e.g., as further described herein with reference to FIG. 2A). A second example may include the memory system moving the data that may be valid at the memory system but invalid at the host system to a temporary memory block other than the source memory block (e.g., as further described herein with reference to FIG. 2B). In some examples, the memory system may refrain from transferring the invalid data 225 of the first memory block 205, while in other examples the memory system may also transfer the invalid data 225 to another memory block 230. For example, a third example may include the memory system keeping the data that may be valid at the memory system but invalid at the host system in the source memory block, and yet releasing the source memory block until an unmap command is received (e.g., as further described herein with reference to FIG. 2C). The memory system may designate the first memory block 205 as a free memory block in response to transferring the valid data 220, and may utilize the newly freed first memory block 205 in future write operations.

FIG. 2A illustrates an example of the memory block configuration 200-a that supports data block validity for maintenance operations in accordance with examples as disclosed herein. The memory block configuration 200-a may include a memory block 205-a and a memory block 210-a, which may be examples of blocks 170 as described with reference to FIG. 1. In some examples, the memory block 205-a may be an example of a source memory block, and the memory block 210-a may be an example of a destination (e.g., secondary, temporary) memory block. As used herein, a source memory block may refer to a memory block 205 that may store data at the start of a maintenance operation and a destination memory block may be referred to as a memory block 205 that may receive data from the source block (e.g., data may be transferred from the source block to the destination block), and may store data for future use or may temporarily store data to until the data is deleted.

In some examples, the memory system may discard invalid data 225 as part of a background or release operation 215-a, to preserve data that is valid at both the memory system and at the host system. In response to receiving an indication of validity from an external source (e.g., a host system), the memory system may determine that the memory block 205-a includes one or more pages of the valid data 220 and one or more pages of the invalid data 225. During the release operation 215-a, the memory system may transfer the valid data 220 from the memory block 205-a to a temporary memory block 210-a. In the example of FIG. 2A, the memory system may discard the invalid data 225 from the memory block 205-a during the release operation 215-a. In some examples, the memory system may discard the invalid data 225 in response to receiving a command, such as an unmap command, from an external source. As used herein, an unmap command may refer to a command received from a host system that indicates (e.g., to the memory system) that one or more memory blocks 205 or a range of storage within a memory block 205 may no longer in use and may be reclaimed (e.g., reused in future access operations). That is, a memory block 205 may be freed for future use based on the memory system receiving an unmap command.

In some examples, rather than wait for an unmap command or another command to initiate the removal of the invalid data, the memory system may automatically perform one or more unmap operations to remove the invalid data 225 from the memory block 205-a and designate the memory block 205-a as a free block (e.g., release the memory block 205-a). Based on transferring the valid data 220 from the memory block 205-a to the memory block 210-a, the memory system may designate the memory block 205-a as a free block (e.g., may release the memory block 205-a). As such, the memory block 205-a may be able (e.g., freed up) to store new data.

In some examples, the memory system may automatically perform one or more unmap operations according to a self-unmap mode. For example, the memory system may be enabled to perform unmap operations without receiving an unmap command from an external source (e.g., a host system). The memory system may indicate the ability of the memory system to perform self-unmap operations to the host system. The host system may, in some instances, enable the self-unmap mode (e.g., by transmitting a VU command or a new descriptor). In self-unmap mode, the memory system may automatically unmap data during the release operation 215-a. For example, during the release operation 215-a while in self-unmap mode, the memory system may retrieve validity information from a bitmap for each LBA from the SIT structure. For the valid data 220, the memory system may rebuild associated PVTs and L2P tables to move the LBA of the valid data 220 into the temporary memory block 210-a. For the invalid data 225, the memory system may directly invalidate the associated PVTs and L2P tables of the invalid data 225. After moving the valid data 220 and invalidating the invalid data 225, the memory system may release the memory block 205-a.

FIG. 2B illustrates an example of the memory block configuration 200-b that supports data block validity for maintenance operations in accordance with examples as disclosed herein. The memory block configuration 200-b may include a memory block 205-b, a memory block 210-b, and a memory block 230, which may be examples of blocks 170 as described with reference to FIG. 1. In some examples, the memory block 205-b may be an example of a source memory block, and the memory block 210-a and the memory block 230 may be examples of destination (e.g., secondary, temporary) memory blocks.

In some examples, the memory system may transfer both invalid data 225 and valid data 220 as part of a background or release operation 215-b, to preserve data that is valid at both the memory system and at the host system. In response to receiving an indication of validity from an external source, the memory system may determine that the memory block 205-b includes one or more pages of the valid data 220 (e.g., valid to the host system and memory system) and one or more pages of the invalid data 225 (e.g., invalid to the host system). During the release operation 215-b, the memory system may transfer the valid data 220 from the memory block 205-b to a temporary memory block 210-b. In the example of FIG. 2B, the memory system may also transfer the invalid data 225 from the memory block 205-a during the release operation 215-a. For example, during the release operation 215-a, the memory system may transfer the invalid data 225 from the memory block 205-b to a second temporary memory block 230. Based on transferring the valid data 220 from the memory block 205-b to the memory block 210-b, the memory system may designate the memory block 205-b as a free block (e.g., may release the memory block 205-b). As such, the memory block 205-b may be able to store new data. The memory system may receive an unmap command, and may also release the memory block 230 in response to receiving the unmap command, which may allow for the removal of the invalid data 225.

FIG. 2C may be an example of the memory block configuration 200-c that supports data block validity for maintenance operations in accordance with examples as disclosed herein. The memory block configuration 200-c may include a memory block 205-c and a memory block 210-c, which may be examples of blocks 170 as described with reference to FIG. 1. In some examples, the memory block 205-c may be an example of a source memory block, and the memory block 210-c may be an example of a destination (e.g., secondary, temporary) memory block.

In some examples, the memory system may retain invalid data 225 (e.g., temporarily) as part of a background or release operation 215-c. In response to receiving an indication of validity from an external source, the memory system may determine that the memory block 205-c includes one or more pages of the valid data 220 and one or more pages of the invalid data 225. During the release operation 215-c, the memory system may transfer the valid data 220 from the memory block 205-c to a temporary memory block 210-c. In the example of FIG. 2C, the invalid data 225 may remain in the memory block 205-c after the valid data 220 is transferred. In some examples, the memory system may discard the invalid data 225 in response to receiving a command, such as an unmap command, from an external source. For example, the memory system may receive an unmap command, and may release the memory block 205-c in response to receiving the unmap command (e.g., and based on transferring the valid data 220 from the memory block 205-c to the memory block 210-c), which may allow for the removal of the invalid data 225. By releasing the memory block 205-c, the memory system may designate the memory block 205-c as a free block such that the memory block 205-c may be able to store new data.

By identifying which memory blocks of the memory system are valid and invalid, the memory system may be enabled to perform one or more operations to preserve valid data. For example, the memory system may utilize validity information of the memory blocks to determine which of the memory blocks are valid at both the memory system and an associated host system, and perform one or more operations to retain valid data while removing invalid data using less process steps.

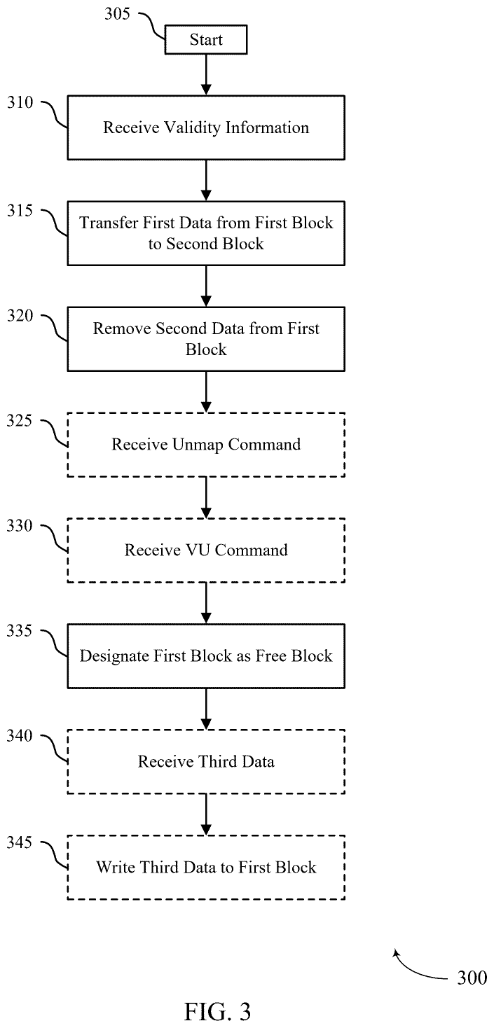

FIG. 3 shows an example of a process 300 that supports data block validity for maintenance operations in accordance with examples as disclosed herein. The operations of process 300 may be performed by a memory system or one or more controllers associated with a memory system as described herein. For example, the operations of process 300 may be performed by a memory system 110 or a controller thereof. The process 300 may also include reference to memory blocks, which may be examples of blocks 170, memory block 205, memory block 210, and memory block 230 as described with reference to FIGS. 1, 2A, 2B, and 2C.

At 305, data block validity operations may begin. For example, the memory system may begin operations associated with data block validity indications for use in maintenance operations. The techniques associated with data block validity indications for use in maintenance operations (e.g., starting with 305) may be examples of operations associated with determining and storing data block validity indications for use in maintenance operations as described with reference to FIGS. 2A and 2B.

At 310, validity information may be received. For example, the memory system may receive validity information. The validity information may indicate a validity of one or more pages of a first block of memory cells (e.g., a first memory block) and may be associated with (e.g., a portion of) a SIT. In some examples, the memory system may receive the validity information from an associated host system. In other examples, the memory system may receive the validity information from another external source. In some cases, the memory system may receive the validity information as part of a VU command. For example, the memory system may receive a VU command including the validity information. In response to receiving the validity information, the memory system may store the validity information to a memory block of the memory system. In some examples, the memory block storing the validity information may be the same as the first memory block, and in other cases the memory block may be an example of another memory block of the memory system.

At 315, first data may be transferred from the first memory block. For example, the memory system may transfer first data from the first memory block to a second memory block. The memory system may determine the validity information to indicate that first data stored to one or more pages of the first memory block is valid at both the memory system and an external source. In response to determining that the first data is valid, the memory system may transfer the first data from the first memory block to a second memory block of the memory system. In some examples, the memory system may transfer the first data to the second memory block as part of a background or maintenance operation of the memory system.

At 320, second data may be removed from the first memory block. For example, the memory system may remove second data from the first memory block. The memory system may determine the validity information to indicate that second data stored to one or more other pages of the first memory block is invalid at the external source. In response to determining that the second data is invalid, the memory system may remove the second data from the first memory block. In some examples, to remove the second data from the first memory block, the memory system may erase (e.g., delete) the second data from the first memory block. In other examples, to remove the second data from the first memory block, the memory system may transfer the second data from the pages of the first memory block to one or more pages of a third memory block. The memory system may then erase the second data from the pages of the third memory block after transferring the second data to the third memory block.

At 325, an unmap command may be received. In some examples, the memory system may receive an unmap command. After removing the second data from the first memory block, the memory system may receive a command to perform one or more unmap operations, which may enable the memory system to designate the first memory block as a free memory block.

At 330, a VU command may be received. In some examples, the memory system may receive a VU command. For example, instead of receiving an unmap command, the memory system may receive another VU command that may enable the memory system to designate the first memory block as a free memory block.

At 335, the first memory block may be designated as a free block. For example, the memory system may designate the first memory block as a free memory block. After transferring the first data to the second memory block and after removing the second data from the first memory block, the memory system may designate the first memory block as a free memory block. In some examples, the memory system may designate the first memory block as a free memory block in response to receiving the unmap command. In other examples, the memory system may designate the first memory block as a free memory block in response to receiving the VU command. In the case that the memory system may receive the VU command, the memory system may not need to receive an unmap command associated with the first data or the second data in order to designate the first memory block as a free memory block. In some other examples, the memory system may automatically designate the first memory block as a free memory block in response to erasing the second data from the third memory block and as part of a self-unmap operation (e.g., as further described with reference to FIG. 2A).

At 340, third data may be received. For example, the memory system may receive third data. After designating the first memory block as a free block, the memory system may receive third data to be written to the memory system.

At 345, the third data may be written to the first memory block. For example, the memory system may write the third data to the first memory block. In response to designating the first memory block as a free block, the memory system may write the received third data to the first memory block.

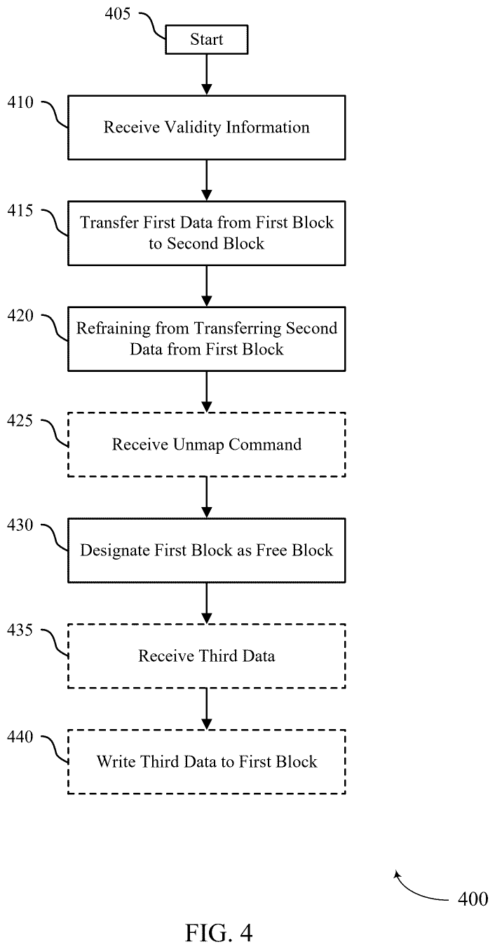

FIG. 4 shows an example of a process 400 that supports data block validity for maintenance operations in accordance with examples as disclosed herein. The operations of process 400 may be performed by a memory system or one or more controllers associated with a memory system as described herein. For example, the operations of process 400 may be performed by a memory system 110 or a controller thereof. The process 400 may also include reference to memory blocks, which may be examples of blocks 170, memory block 205, memory block 210, and memory block 230 as described with reference to FIGS. 1, 2A, 2B, and 2C.

At 405, data block validity operations may begin. For example, the memory system may begin operations associated with data block validity indications for use in maintenance operations. The techniques associated with data block validity indications for use in maintenance operations (e.g., starting with 405) may be examples of operations associated with determining and storing data block validity indications for use in maintenance operations as described with reference to FIG. 2C.

At 410, validity information may be received. For example, the memory system may receive validity information. The validity information may indicate a validity of one or more pages of a first block of memory cells (e.g., a first memory block) and may be associated with (e.g., a portion of) a SIT. In some examples, the memory system may receive the validity information from an associated host system. In other examples, the memory system may receive the validity information from another external source. In some cases, the memory system may receive the validity information as part of a VU command. For example, the memory system may receive a VU command including the validity information. In response to receiving the validity information, the memory system may store the validity information to a memory block of the memory system. In some examples, the memory block storing the validity information may be the same as the first memory block, and in other cases the memory block may be an example of another memory block of the memory system.

At 415, first data may be transferred from the first memory block. For example, the memory system may transfer first data from the first memory block to a second memory block. For example, the memory system may determine the validity information to indicate that first data stored to one or more pages of the first memory block is valid at both the memory system and an external source. In response to determining that the first data is valid, the memory system may transfer the first data from the first memory block to a second memory block of the memory system. In some examples, the memory system may transfer the first data to the second memory block as part of a background or maintenance operation of the memory system.

At 420, second data may not be transferred from the first memory block. For example, the memory system may refrain from transferring second data from the first memory block. The memory system may determine the validity information to indicate that second data stored to one or more other pages of the first memory block is invalid at the external source and valid at the memory system. In response to determining that the second data is invalid at the host system, the memory system may refrain from transferring the second data from the first memory block, such that the second data may remain in the first memory block.

At 425, an unmap command may be received. In some examples, the memory system may receive an unmap command. After refraining from transferring the second data from the first memory block and after transferring the first data to the second memory block, the memory system may receive a command to perform one or more unmap operations, which may enable the memory system to designate the first memory block as a free memory block.

At 430, the first memory block may be designated as a free block. For example, the memory system may designate the first memory block as a free memory block. In response to receiving the unmap command, the memory system may designate the first memory block as a free memory block. In some examples, designating the first memory block as a free block may include the memory system erasing the second data from the first memory block.

At 435, third data may be received. For example, the memory system may receive third data. After designating the first memory block as a free block, the memory system may receive third data to be written to the memory system.

At 440, the third data may be written to the first memory block. For example, the memory system may write the third data to the first memory block. In response to designating the first memory block as a free block, the memory system may write the received third data to the first memory block.

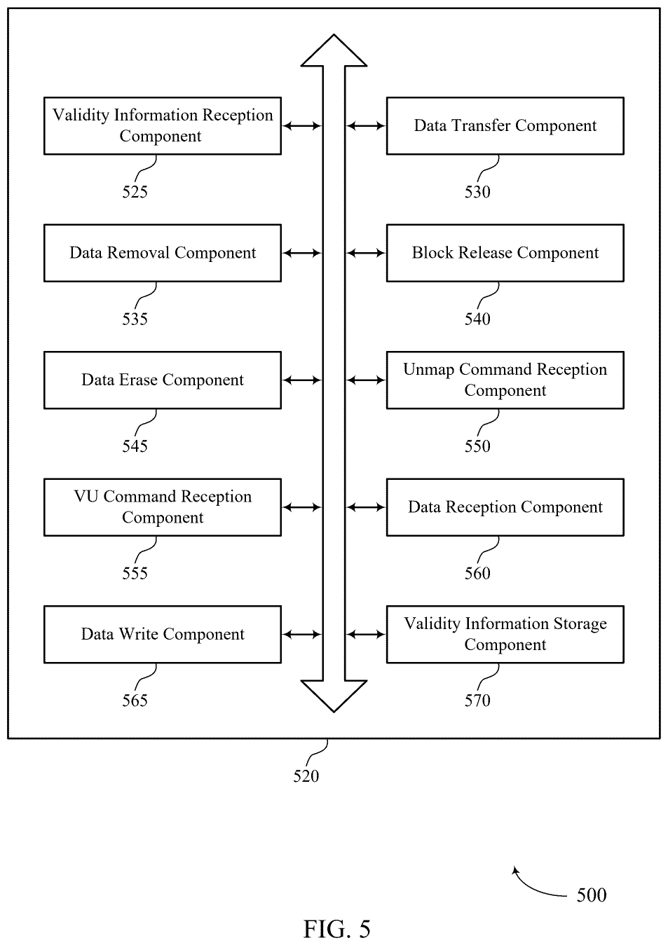

FIG. 5 shows a block diagram 500 of a memory system 520 that supports data block validity for maintenance operations in accordance with examples as disclosed herein. The memory system 520 may be an example of aspects of a memory system as described with reference to FIGS. 1 through 4. The memory system 520, or various components thereof, may be an example of means for performing various aspects of data block validity for maintenance operations as described herein. For example, the memory system 520 may include a validity information reception component 525, a data transfer component 530, a data removal component 535, a block release component 540, a data erase component 545, an unmap command reception component 550, a VU command reception component 555, a data reception component 560, a data write component 565, a validity information storage component 570, or any combination thereof. Each of these components, or components of subcomponents thereof (e.g., one or more processors, one or more memories), may communicate, directly or indirectly, with one another (e.g., via one or more buses).

The validity information reception component 525 may be configured as or otherwise support a means for receiving information indicating a validity of one or more pages of a first block of non-volatile memory cells. The data transfer component 530 may be configured as or otherwise support a means for transferring first data from the first block to a second block of non-volatile memory cells in accordance with the information indicating the validity of the one or more pages, where the information indicating that the first data is valid. The data removal component 535 may be configured as or otherwise support a means for removing second data from a second page of the first block in accordance with the information indicating that the second data is invalid. The block release component 540 may be configured as or otherwise support a means for designating the first block as a free block in accordance with transferring the first data and removing the second data.

In some examples, to support removing the second data from the second page of the first block, the data erase component 545 may be configured as or otherwise support a means for erasing the second data, where the first block is designated as a free block in accordance with erasing the second data.

In some examples, to support removing the second data from the second page of the first block, the data transfer component 530 may be configured as or otherwise support a means for transferring the second data to a third page of a third block, where the first block is designated as a free block in accordance with transferring the second data to the third page of the third block.

In some examples, the data erase component 545 may be configured as or otherwise support a means for erasing the second data from the third page of the third block after transferring the second data to the third page of the third block. In some examples, the block release component 540 may be configured as or otherwise support a means for designating the third block as a free block in accordance with erasing the second data from the third page of the third block.

In some examples, the unmap command reception component 550 may be configured as or otherwise support a means for receiving an unmap command after removing the second data from the second page of the first block, where designating the first block as the free block is in accordance with receiving the unmap command.

In some examples, the VU command reception component 555 may be configured as or otherwise support a means for receiving a vendor unique command prior to designating the first block as a free block, where the vendor unique command enables the memory system to designate the first block as a free block without receiving an unmap command, where the memory system designates the first block as a free block in accordance with receiving the vendor unique command.

In some examples, the memory system designates the first block as a free block without receiving an unmap command for the second data that is indicated as invalid by the information.

In some examples, the data reception component 560 may be configured as or otherwise support a means for receiving third data after designating the first block as a free block. In some examples, the data write component 565 may be configured as or otherwise support a means for writing the third data to the first block in response to receiving the third data.

In some examples, the information indicating the validity of the one or more pages of the first block is received as part of a vendor unique command.

In some examples, the first data is transferred to the second block and the second data is removed from the first block during a maintenance operation.

In some examples, the validity information storage component 570 may be configured as or otherwise support a means for storing the information indicating the validity of the one or more pages of the first block to a fourth block of non-volatile memory cells.

In some examples, the second data is valid to the memory system and invalid to a host system coupled with the memory system. In some examples, the information is received from the host system.

In some examples, the information is associated with a segment information table (e.g., a SIT).

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

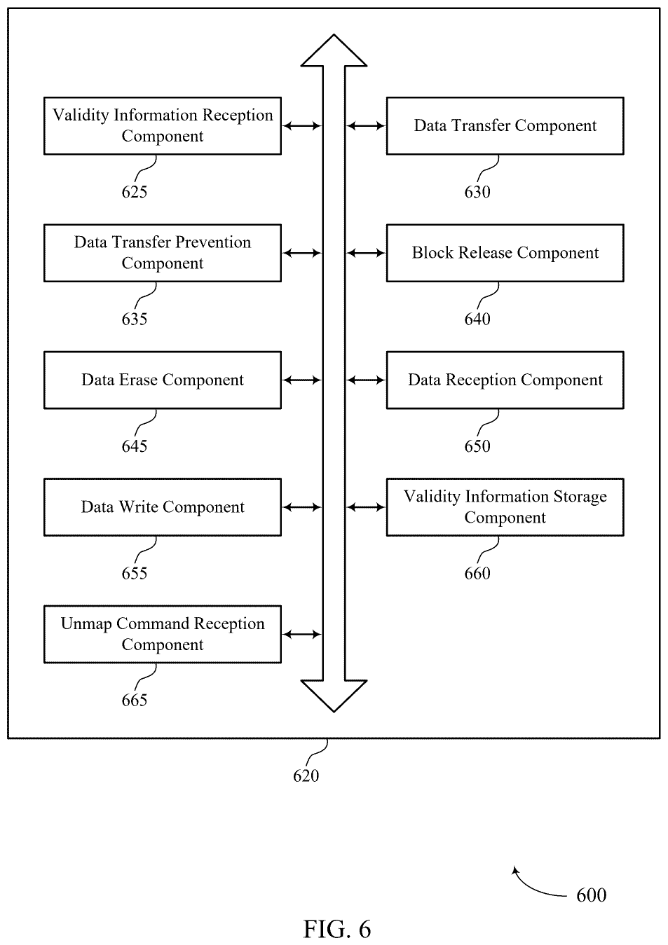

FIG. 6 shows a block diagram 600 of a memory system 620 that supports data block validity for maintenance operations in accordance with examples as disclosed herein. The memory system 620 may be an example of aspects of a memory device as described with reference to FIGS. 1 through 4. The memory system 620, or various components thereof, may be an example of means for performing various aspects of data block validity for maintenance operations as described herein. For example, the memory system 620 may include a validity information reception component 625, a data transfer component 630, a data transfer prevention component 635, a block release component 640, a data erase component 645, a data reception component 650, a data write component 655, a validity information storage component 660, an unmap command reception component 665, or any combination thereof. Each of these components, or components of subcomponents thereof (e.g., one or more processors, one or more memories), may communicate, directly or indirectly, with one another (e.g., via one or more buses).

The validity information reception component 625 may be configured as or otherwise support a means for receiving information indicating a validity of one or more pages of a first block of non-volatile memory cells. The data transfer component 630 may be configured as or otherwise support a means for transferring first data from the first block to a second block of non-volatile memory cells in accordance with the information indicating the validity of the one or more pages, where the information indicating that the first data is valid. The data transfer prevention component 635 may be configured as or otherwise support a means for refraining from transferring second data stored to the first block of non-volatile memory cells in accordance with the information indicating the second data is invalid. The block release component 640 may be configured as or otherwise support a means for designating the first block as a free block in accordance with transferring the first data and refraining from transferring the second data.

In some examples, to support designating the first block as the free block, the data erase component 645 may be configured as or otherwise support a means for erasing the second data from the second page of the second block in response to receiving an unmap command.

In some examples, the unmap command reception component 665 may be configured as or otherwise support a means for receiving the unmap command after refraining from transferring the second data stored to the first block.

In some examples, the data reception component 650 may be configured as or otherwise support a means for receiving third data after designating the first block as a free block. In some examples, the data write component 655 may be configured as or otherwise support a means for writing the third data to the first block in response to receiving the third data.

In some examples, the information indicating the validity of the one or more pages of the first block is received as part of a vendor unique command.

In some examples, the first data is transferred to the second block during a maintenance operation.

In some examples, the validity information storage component 660 may be configured as or otherwise support a means for storing the information indicating the validity of the one or more pages of the first block to a third block of non-volatile memory cells.

In some examples, the second data is valid to the memory system and invalid to a host system coupled with the memory system. In some examples, the information is received from the host system.

In some examples, the information is associated with a segment information table (e.g., a SIT).

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

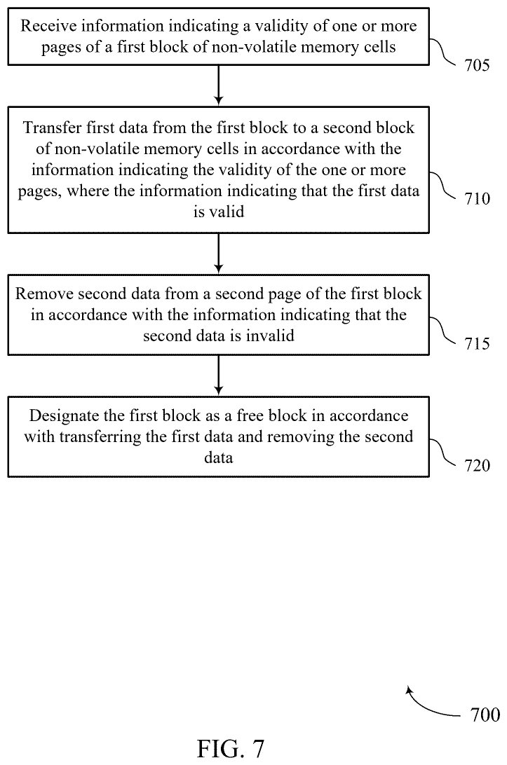

FIG. 7 shows a flowchart illustrating a method 700 that supports data block validity for maintenance operations in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include receiving information indicating a validity of one or more pages of a first block of non-volatile memory cells. In some examples, aspects of the operations of 705 may be performed by a validity information reception component 525 as described with reference to FIG. 5.

At 710, the method may include transferring first data from the first block to a second block of non-volatile memory cells in accordance with the information indicating the validity of the one or more pages, where the information indicating that the first data is valid. In some examples, aspects of the operations of 710 may be performed by a data transfer component 530 as described with reference to FIG. 5.

At 715, the method may include removing second data from a second page of the first block in accordance with the information indicating that the second data is invalid. In some examples, aspects of the operations of 715 may be performed by a data removal component 535 as described with reference to FIG. 5.

At 720, the method may include designating the first block as a free block in accordance with transferring the first data and removing the second data. In some examples, aspects of the operations of 720 may be performed by a block release component 540 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving information indicating a validity of one or more pages of a first block of non-volatile memory cells; transferring first data from the first block to a second block of non-volatile memory cells in accordance with the information indicating the validity of the one or more pages, where the information indicating that the first data is valid; removing second data from a second page of the first block in accordance with the information indicating that the second data is invalid; and designating the first block as a free block in accordance with transferring the first data and removing the second data.

Aspect 2: The method, apparatus, or non-transitory computer-readable medium of aspect 1, where removing the second data from the second page of the first block includes operations, features, circuitry, logic, means, or instructions, or any combination thereof for erasing the second data, where the first block is designated as a free block in accordance with erasing the second data.

Aspect 3: The method, apparatus, or non-transitory computer-readable medium of any of aspects 1 through 2, where removing the second data from the second page of the first block includes operations, features, circuitry, logic, means, or instructions, or any combination thereof for transferring the second data to a third page of a third block, where the first block is designated as a free block in accordance with transferring the second data to the third page of the third block.

Aspect 4: The method, apparatus, or non-transitory computer-readable medium of aspect 3, further including operations, features, circuitry, logic, means, or instructions, or any combination thereof for erasing the second data from the third page of the third block after transferring the second data to the third page of the third block and designating the third block as a free block in accordance with erasing the second data from the third page of the third block.

Aspect 5: The method, apparatus, or non-transitory computer-readable medium of any of aspects 1 through 4, further including operations, features, circuitry, logic, means, or instructions, or any combination thereof for receiving an unmap command after removing the second data from the second page of the first block, where designating the first block as the free block is in accordance with receiving the unmap command.

Aspect 6: The method, apparatus, or non-transitory computer-readable medium of any of aspects 1 through 5, further including operations, features, circuitry, logic, means, or instructions, or any combination thereof for receiving a vendor unique command prior to designating the first block as a free block, where the vendor unique command enables the memory system to designate the first block as a free block without receiving an unmap command, where the memory system designates the first block as a free block in accordance with receiving the vendor unique command.

Aspect 7: The method, apparatus, or non-transitory computer-readable medium of aspect 6, where the memory system designates the first block as a free block without receiving an unmap command for the second data that is indicated as invalid by the information.

Aspect 8: The method, apparatus, or non-transitory computer-readable medium of any of aspects 1 through 7, further including operations, features, circuitry, logic, means, or instructions, or any combination thereof for receiving third data after designating the first block as a free block and writing the third data to the first block in response to receiving the third data.

Aspect 9: The method, apparatus, or non-transitory computer-readable medium of any of aspects 1 through 8, where the information indicating the validity of the one or more pages of the first block is received as part of a vendor unique command.

Aspect 10: The method, apparatus, or non-transitory computer-readable medium of any of aspects 1 through 9, where the first data is transferred to the second block and the second data is removed from the first block during a maintenance operation.

Aspect 11: The method, apparatus, or non-transitory computer-readable medium of any of aspects 1 through 10, further including operations, features, circuitry, logic, means, or instructions, or any combination thereof for storing the information indicating the validity of the one or more pages of the first block to a fourth block of non-volatile memory cells.

Aspect 12: The method, apparatus, or non-transitory computer-readable medium of any of aspects 1 through 11, where the second data is valid to the memory system and invalid to a host system coupled with the memory system and the information is received from the host system.

Aspect 13: The method, apparatus, or non-transitory computer-readable medium of any of aspects 1 through 12, where the information is associated with a SIT.

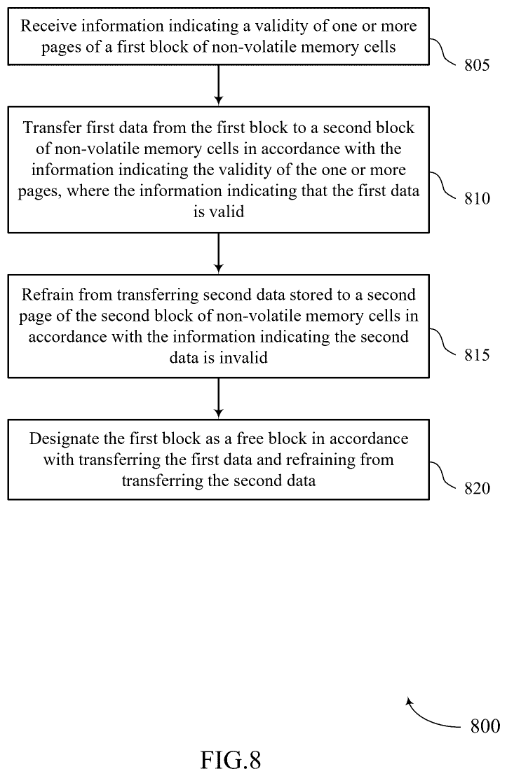

FIG. 8 shows a flowchart illustrating a method 800 that supports data block validity for maintenance operations in accordance with examples as disclosed herein. The operations of method 800 may be implemented by a memory device or its components as described herein. For example, the operations of method 800 may be performed by a memory device as described with reference to FIGS. 1 through 4 and 6. In some examples, a memory device may execute a set of instructions to control the functional elements of the device to perform the described functions. Additionally, or alternatively, the memory device may perform aspects of the described functions using special-purpose hardware.

At 805, the method may include receiving information indicating a validity of one or more pages of a first block of non-volatile memory cells. In some examples, aspects of the operations of 805 may be performed by a validity information reception component 625 as described with reference to FIG. 6.

At 810, the method may include transferring first data from the first block to a second block of non-volatile memory cells in accordance with the information indicating the validity of the one or more pages, where the information indicating that the first data is valid. In some examples, aspects of the operations of 810 may be performed by a data transfer component 630 as described with reference to FIG. 6.

At 815, the method may include refraining from transferring second data stored to the first block of non-volatile memory cells in accordance with the information indicating the second data is invalid. In some examples, aspects of the operations of 815 may be performed by a data transfer prevention component 635 as described with reference to FIG. 6.

At 820, the method may include designating the first block as a free block in accordance with transferring the first data and refraining from transferring the second data. In some examples, aspects of the operations of 820 may be performed by a block release component 640 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 14: A method, apparatus, or non-transitory computer-readable medium including operations, features, circuitry, logic, means, or instructions, or any combination thereof for receiving information indicating a validity of one or more pages of a first block of non-volatile memory cells; transferring first data from the first block to a second block of non-volatile memory cells in accordance with the information indicating the validity of the one or more pages, where the information indicating that the first data is valid; refraining from transferring second data stored to the first block of non-volatile memory cells in accordance with the information indicating the second data is invalid; and designating the first block as a free block in accordance with transferring the first data and refraining from transferring the second data.

Aspect 15: The method, apparatus, or non-transitory computer-readable medium of aspect 14, where designating the first block as the free block includes operations, features, circuitry, logic, means, or instructions, or any combination thereof for erasing the second data from the second page of the second block in response to receiving an unmap command.

Aspect 16: The method, apparatus, or non-transitory computer-readable medium of aspect 15, further including operations, features, circuitry, logic, means, or instructions, or any combination thereof for receiving the unmap command after refraining from transferring the second data stored to the first block.

Aspect 17: The method, apparatus, or non-transitory computer-readable medium of any of aspects 14 through 16, further including operations, features, circuitry, logic, means, or instructions, or any combination thereof for receiving third data after designating the first block as a free block and writing the third data to the first block in response to receiving the third data.

Aspect 18: The method, apparatus, or non-transitory computer-readable medium of any of aspects 14 through 17, where the information indicating the validity of the one or more pages of the first block is received as part of a vendor unique command.

Aspect 19: The method, apparatus, or non-transitory computer-readable medium of any of aspects 14 through 18, where the first data is transferred to the second block during a maintenance operation.

Aspect 20: The method, apparatus, or non-transitory computer-readable medium of any of aspects 14 through 19, further including operations, features, circuitry, logic, means, or instructions, or any combination thereof for storing the information indicating the validity of the one or more pages of the first block to a third block of non-volatile memory cells.

Aspect 21: The method, apparatus, or non-transitory computer-readable medium of any of aspects 14 through 20, where the second data is valid to the memory system and invalid to a host system coupled with the memory system and the information is received from the host system.

Aspect 22: The method, apparatus, or non-transitory computer-readable medium of any of aspects 14 through 21, where the information is associated with a SIT.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive information indicating a validity of one or more pages of a first block of non-volatile memory cells;
transfer first data from the first block to a second block of non-volatile memory cells in accordance with the information indicating the validity of the one or more pages, wherein the information indicating that the first data is valid;
remove second data from a second page of the first block in accordance with the information indicating that the second data is invalid; and
designate the first block as a free block in accordance with transferring the first data and removing the second data.

2. The memory system of claim 1, wherein removing the second data from the second page of the first block comprises the processing circuitry configured to cause the memory system to:
erase the second data, wherein the first block is designated as a free block in accordance with erasing the second data.

3. The memory system of claim 1, wherein removing the second data from the second page of the first block comprises the processing circuitry configured to cause the memory system to:
transfer the second data to a third page of a third block, wherein the first block is designated as a free block in accordance with transferring the second data to the third page of the third block.

4. The memory system of claim 3, wherein the processing circuitry is further configured to cause the memory system to:
erase the second data from the third page of the third block after transferring the second data to the third page of the third block; and
designate the third block as a free block in accordance with erasing the second data from the third page of the third block.

5. The memory system of claim 1, wherein the processing circuitry is further configured to cause the memory system to:
receive an unmap command after removing the second data from the second page of the first block, wherein designating the first block as the free block is in accordance with receiving the unmap command.

6. The memory system of claim 1, wherein the processing circuitry is further configured to cause the memory system to:
receive a vendor unique command prior to designating the first block as a free block, wherein the vendor unique command enables the memory system to designate the first block as a free block without receiving an unmap command, wherein the memory system designates the first block as a free block in accordance with receiving the vendor unique command.

7. The memory system of claim 6, wherein the memory system designates the first block as a free block without receiving an unmap command for the second data that is indicated as invalid by the information.

8. The memory system of claim 1, wherein the processing circuitry is further configured to cause the memory system to:
receive third data after designating the first block as a free block; and
write the third data to the first block in response to receiving the third data.

9. The memory system of claim 1, wherein the information indicating the validity of the one or more pages of the first block is received as part of a vendor unique command.

10. The memory system of claim 1, wherein the first data is transferred to the second block and the second data is removed from the first block during a maintenance operation.

11. The memory system of claim 1, wherein the processing circuitry is further configured to cause the memory system to:
store the information indicating the validity of the one or more pages of the first block to a fourth block of non-volatile memory cells.

12. The memory system of claim 1, wherein:
the second data is valid to the memory system and invalid to a host system coupled with the memory system, and
the information is received from the host system.

13. The memory system of claim 1, wherein the information is associated with a segment information table (SIT).

14. A memory system, comprising:
one or more memory devices; and
processing circuitry coupled with the one or more memory devices and configured to cause the memory system to:
receive information indicating a validity of one or more pages of a first block of non-volatile memory cells;
transfer first data from the first block to a second block of non-volatile memory cells in accordance with the information indicating the validity of the one or more pages, wherein the information indicating that the first data is valid;
refrain from transferring second data stored to the first block of non-volatile memory cells in accordance with the information indicating the second data is invalid; and
designate the first block as a free block in accordance with transferring the first data and refraining from transferring the second data.

15. The memory system of claim 14, wherein designating the first block as the free block comprises the processing circuitry configured to cause the memory system to:
erase the second data from the first block in response to receiving an unmap command.

16. The memory system of claim 15, wherein the processing circuitry is further configured to cause the memory system to:
receive the unmap command after refraining from transferring the second data stored to the first block.

17. The memory system of claim 14, wherein the processing circuitry is further configured to cause the memory system to:
receive third data after designating the first block as a free block; and
write the third data to the first block in response to receiving the third data.

18. The memory system of claim 14, wherein the information indicating the validity of the one or more pages of the first block is received as part of a vendor unique command.

19. The memory system of claim 14, wherein the first data is transferred to the second block during a maintenance operation.

20. The memory system of claim 14, wherein the processing circuitry is further configured to cause the memory system to:
store the information indicating the validity of the one or more pages of the first block to a third block of non-volatile memory cells.

21. The memory system of claim 14, wherein:
the second data is valid to the memory system and invalid to a host system coupled with the memory system, and
the information is received from the host system.

22. The memory system of claim 14, wherein the information is associated with a segment information table (SIT).

23. A non-transitory computer-readable medium storing code, the code comprising instructions executable by one or more processors to:
receive information indicating a validity of one or more pages of a first block of non-volatile memory cells;
transfer first data from the first block to a second block of non-volatile memory cells in accordance with the information indicating the validity of the one or more pages, wherein the information indicating that the first data is valid;
remove second data from a second page of the first block in accordance with the information indicating that the second data is invalid; and
designate the first block as a free block in accordance with transferring the first data and removing the second data.

24. The non-transitory computer-readable medium of claim 23, wherein the instructions to remove the second data from the second page of the first block are executable by the one or more processors to:
erase the second data, wherein the first block is designated as a free block in accordance with erasing the second data.

25. The non-transitory computer-readable medium of claim 23, wherein the instructions to remove the second data from the second page of the first block are executable by the one or more processors to:
transfer the second data to a third page of a third block, wherein the first block is designated as a free block in accordance with transferring the second data to the third page of the third block.
